(19) United States
(12) Patent Application Publication
(10) Pub. No.: US 2025/0386377 A1
(43) Pub. Date: Dec. 18, 2025

(54) SYSTEM, METHOD, USER EQUIPMENT AND BASE STATION FOR PERFORMING A HANDOVER IN A WIRELESS NETWORK

(71) Applicant: Continental Automotive Technologies GmbH, Hannover (DE)

(72) Inventors: Andreas Andrae, Frankfurt am Main (DE); Rikin Shah, Langen (DE); Reuben George Stephen, Singapore (SG); David Gonzalez Gonzalez, Egelsbach (DE); Hojin Kim, Regensburg (DE); Shravan Kumar Kalyankar, Singapore (SG); Osvaldo Gonsa, Frankfurt (DE)

(73) Assignee: Continental Automotive Technologies GmbH, Hannover (DE)

(21) Appl. No.: 18/878,681

(22) PCT Filed: Jun. 20, 2023
(86) PCT No.: PCT/EP2023/066591

§ 371 Date: Dec. 24, 2024

(30) Foreign Application Priority Data
Jun. 24, 2022 (DE) 10 2022 206 396.1

(51) Int. Cl. H04W 74/0833; H04W 36/00; H04W 72/12

(52) U.S. Cl. CPC H04W 74/0833; H04W 36/00837; H04W 72/12

(57) ABSTRACT

Wireless communication by a user equipment supports a handover from a first base station to a second base station. A random access scheduling configuration is obtained for at least said user equipment. The configuration includes at least a Random Access delay value. A timer, which is configured according to the Random Access Delay value, is started upon reception of a handover command from the first base station. A delayed random access procedure is triggered to the second base station when timer expires.

### CROSS-REFERENCE TO RELATED APPLICATIONS

The present application is a National Stage Application under 35 U.S.C. § 371 of International Patent Application No. PCT/EP2023/066591 filed on Jun. 20, 2023, and claims priority from German Patent Application No. 10 2022 206 396.1 filed on Jun. 24, 2022, the disclosures of which are herein incorporated by reference in their entireties.

### TECHNICAL FIELD

The following relates generally to wireless communications, and more particularly to a method of improved handover in non-terrestrial networks.

### BACKGROUND

Wireless communication systems are widely deployed to provide various types of communication content such as voice, video, packet data, messaging, broadcast, and so on.

A wireless multiple-access communication system may include a number of base stations, each supporting communication for multiple mobile devices simultaneously. A base station may communicate with UEs on downstream and upstream links. Each base station has a coverage range, sometimes referred to as a cell coverage area.

Non-Terrestrial Networks (NTN) has become an umbrella term for any network that involves non-terrestrial flying objects, like satellites communication networks or High-Altitude Platforms Systems (HAPS) including airplanes, balloons and airships.

Satellite communication networks rely on spaceborne platforms comprising Low Earth orbiting (LEO) satellites, Medium Earth Orbiting (MEO) satellites, and geosynchronous Earth orbiting (GEO) satellites.

Nowadays, there is a growing interest in the broadband supported by LEO NTNs, with large satellites constellations, because of its advantages in smaller propagation delay and higher link quality than MEO or GEO satellites. The satellite industry is now committed in the 3GPP process to integrate satellite networks into the 5G ecosystem.

The integration of Non-Terrestrial Networks (NTNs) within the 5G framework is under standardization and can lead to manifold advantages, such as wide service coverage capabilities, reduced vulnerability of space/airborne vehicles to physical attacks and natural disasters, or reinforced service reliability.

However, NTN integration is also leading to challenges related to the employment and adaptation to aerospace networks of technologies originally designed for terrestrial networks.

In particular, handover in LEO satellite networks differs significantly from the traditional terrestrial cellular networks in that the handover is triggered by the mobility of the satellite. In terrestrial networks, there are relatively small, fixed cells and moving UE, whereas in non-terrestrial networks, cells are moving along with satellites movements. In comparison, UE movements are slow and sometimes negligible. Once the LEO satellite moves to a new cell, most (if not all) of the UEs will be handed over to another cell.

Considering the large cell size of non-terrestrial networks, many devices may be served within a single cell. Depending on constellation assumptions (e.g., propagation delay and satellite speed) and UE density, a potentially very large number of UEs may need to perform handover at a given time, leading to possibly large signaling overhead and high-power consumption, as well as service continuity challenges. Moreover, if many UEs need to be handed over from one base station to another, then random access collisions would increase among UEs.

There is therefore a need for a method of handover that reduce random access collisions and UE energy consumption.

### BRIEF SUMMARY

In accordance with an aspect of the disclosure, there is provided a method of wireless communication by a user equipment device, for supporting a handover from a first base station to a second base station, the method comprising:
Obtaining a Random Access scheduling configuration for at least said user equipment, said configuration including at least a Random Access delay value,
Starting a timer configured according to said Random Access Delay value upon reception of a handover command from the first base station,
Triggering a delayed Random Access procedure to the second base station when timer expires.

It is therefore proposed that a user equipment obtains a specific RACH delay timer value and waits for that delay to expire before proceeding with random access, for example before transmitting Random access preamble. This way, one can appreciate that random access procedures performed by a set of user equipment therefore spreads out over time, making it possible to reduce the risk of collision events.

In one embodiment, the obtained Random Access scheduling configuration further comprises a Random Access back-off delay value, the method comprising a step of applying said back-off delay value upon Random Access Procedure failure.

The Random Access scheduling configuration obtained by a user equipment device may thus comprise a backoff delay value. Hence, if user equipment's first Random Access attempts fails, user equipment may apply such backoff delay value before starting a new Random Access attempt.

In one embodiment, said Random Access scheduling configuration is obtained from a message comprising said Random Access scheduling configuration.

The Random Access scheduling configuration is transmitted to a user equipment in a message, for example a handover command message. For example, a RRC reconfiguration message may include a random access delay timer and/or a random access backoff timer.

In one embodiment, said message comprising said random access scheduling configuration is received from said first base station.

In one embodiment, said Random Access scheduling configuration obtained for said user equipment is determined according to a QoS profile and/or a priority associated with said user equipment.

This way, the Random Access scheduling configuration (including Random Access delay value and/or Random access backoff value) obtained by a user equipment depends on at least a priority value and/or a Quality Of Service (QoS) profile associated with said user equipment: a high-priority user equipment would thus be provided with a smaller RACH delay timer and/or back-off value than a low priority user equipment.

Such a provision allows the Random access to be spread out over a period, while favoring user equipment with highest priority and/or QoS requirements.

In one embodiment, said message comprising said random access scheduling configuration is received from a second UE using sidelink communication.

A first relay UE may collect random access configurations for a number of attached UE and dispatch these configurations to the corresponding UE. Such a provision reduces signaling overhead.

According to another embodiment, the step of obtaining said Random Access scheduling configuration comprises the following steps:
Receiving a RRC signaling message comprising a QoS parameter,
Looking-up, in a preconfigured lookup table, a Random Access scheduling configuration associated with said received QoS parameter.

A mapping between a QoS parameter and a specific Random Access Scheduling configuration is preconfigured in a user equipment. A Random Access delay is thus determined by the user equipment on the basis of a QoS parameter transmitted by a base station in a RCC message. Such a provision allows a saving of bandwidth resources by reducing the amount of data exchanged between said user equipment and source base station. Moreover, the method could be implemented using a state of art base station using traditional QoS profile transmission from the source base station to the user equipment.

Another aspect of the disclosure relates to a wireless user equipment device for supporting a handover from a first base station to a second base station comprising a processor coupled with a memory with computer program instructions stored therein, wherein said processor is configured by said computer program instructions to:
Obtain a Random Access scheduling configuration for at least said user equipment, said configuration including at least a Random Access delay value,
Start a timer configured according to the determined Random Access Delay value upon reception of a handover command from the first base station,
Trigger a delayed Random Access procedure to the second base station when timer expires.

According to a further aspect of the disclosure, it is provided a method of wireless communication by a first base station for performing a handover of at least one user equipment from a second base station to said first base station, the method comprising:
Receiving, from said second base station, a handover request comprising at least a priority value and/or a QoS profile associated with said user equipment device,
Determining a Random Access scheduling configuration from at least said user equipment priority value and/or QoS profile, said Random Access scheduling configuration including at least a Random Access delay value,
Transmitting to said second base station, a handover response message including said determined Random Access scheduling configuration.

In an embodiment, said Random Access scheduling configuration further comprises a Random Access back-off delay value.

Another aspect of the disclosure relates to a base station for performing a handover of at least one user equipment in a wireless network comprising a processor coupled with a memory with computer program instructions stored therein, wherein said processor is configured by said computer program instructions to implement a method of wireless communication for performing a handover comprising:
Receiving, from said second base station, a handover request comprising at least a priority value and/or a QoS profile associated with said user equipment device,
Determining a Random Access scheduling configuration from at least said user equipment priority value and/or QoS profile, said Random Access scheduling configuration including at least a Random Access delay value,
Transmitting to said second base station, a handover response message including said determined Random Access scheduling configuration.

According to a further aspect, it is proposed a wireless communication system for performing a handover of a user equipment from a first base station to a second base station, the second base station comprising a processor coupled with a memory with computer program instructions stored therein, wherein said processor is configured by said computer program instructions to implement a method of wireless communication for performing a handover comprising:
Receiving, from said first base station, a handover request comprising at least a priority value and/or a QoS profile associated with said user equipment device,
Determining a Random Access scheduling configuration from at least said user equipment priority value and/or QoS profile, said Random Access scheduling configuration including at least a Random Access delay value,
Transmitting to said first base station, a handover response message including said determined Random Access scheduling configuration, and
   Said user equipment device comprising a processor coupled with a memory with computer program instructions stored therein, wherein said processor is configured by said computer program instructions to:
Receive, from said first base station, a Random Access scheduling configuration including at least a Random Access delay value,
Start a timer configured according to the received Random Access Delay value,
Trigger a delayed Random Access procedure to the second base station when timer expires.

In a particular embodiment, the various steps of the wireless communication method for supporting a handover by a user equipment and the wireless communication method for performing a handover by a base station are determined by instructions of computer programs.

Consequently, the disclosure further contemplates computer programs on an information medium, these programs being suitable to be implemented respectively in user equipment device and a base station, or more generally in a computer, these programs respectively comprising instructions adapted to implement the steps of the wireless communication methods respectively supported by a user equipment and performed by a base station which have just been described.

These programs can use any programming language, and be in the form of source code, object code, or of code intermediate between source code and object code, such as in a partially compiled form, or in any other desirable form.

A further aspect contemplates an information medium readable by a computer comprising instructions of a computer program such as mentioned hereinabove.

The information medium may be any entity or device capable of storing the program. For example, the medium can comprise a storage means, such as a ROM, for example a CD ROM or a microelectronic circuit ROM, EEPROM, FLASH memory or any magnetic recording means, for example a hard drive.

Moreover, the information medium may be a transmissible medium such as an electrical or optical signal, which may be conveyed via an electrical or optical cable, by radio or by other means. The program according to an embodiment of the invention may in particular be downloaded from a network.

Alternatively, the information medium may be an integrated circuit into which the program is incorporated, the circuit being arranger to execute or to be used in the execution of the methods in question.

The advantages of the user equipment, the base station, the system, of the corresponding computer programs and information mediums are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings.

FIG. 1 illustrates a wireless communication system arranged to implement a wireless communication method for performing a handover according to an embodiment.

FIG. 2 is a combined flow chart and block diagram illustrating a state-of-the-art inter-cell handover procedure.

FIG. 3a is a combined flow chart and block diagram illustrating the main steps of a method of wireless communication for performing a handing over a UE from a source base station to a target base station, according to an embodiment.

FIG. 3b is a flow chart illustrating steps of a method of wireless communication for supporting a handover by a user equipment device, according to a particular embodiment.

FIG. 3c is a flow chart illustrating steps of a method of wireless communication for performing a handover by a target base station, according to a particular embodiment.

FIG. 4a is a combined flow chart and block diagram illustrating the main steps of a method of wireless communication for performing a handing over a UE from a source base station to a target base station, according to another embodiment.

FIG. 4b is a flow chart illustrating steps of a method of wireless communication for supporting a handover by a user equipment device, according to a particular embodiment.

FIG. 4c is a flow chart illustrating steps of a method of wireless communication for performing a handover by a target base station, according to a particular embodiment.

FIG. 5 is table showing a set of backoff delay values, according to an embodiment.

FIG. 6 is a flow chart illustrating steps of a method of wireless communication for supporting a handover by a user equipment device, according to a particular embodiment.

FIG. 7 is an exemplary mapping table for associating a QoS parameter with random access scheduling parameters, according to an embodiment.

FIG. 8 is a block diagram depicting an architecture of a user equipment apparatus arranged to implement a wireless communication method to perform a handover according to an embodiment.

FIG. 9 is a block diagram depicting an architecture of a base station apparatus arranged to implement a wireless communication method to perform a handover according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention. Also, it should be understood that, although the present disclosure is exemplified with respect to a non-terrestrial base stations, this should not be seen as limiting the scope of the invention, as the teaching of the present disclosure could be applied to terrestrial base stations without modifying the invention.

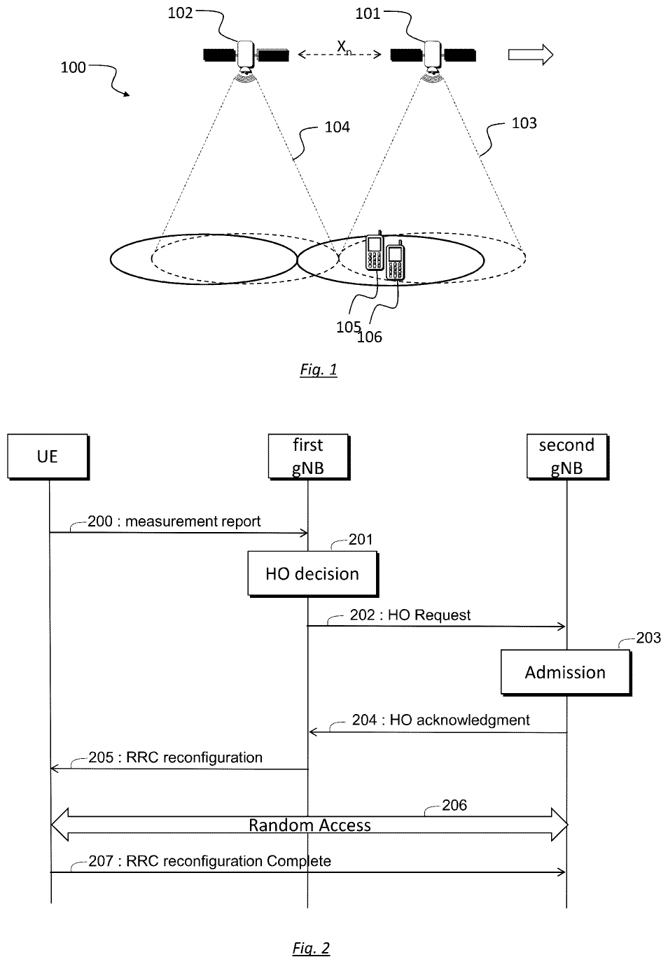

FIG. 1 shows an exemplary 5G New Radio (NR) wireless communication system 100 configured to support a handover procedure in a non-terrestrial network (NTN) in accordance with an embodiment of the disclosure.

The wireless system 100 comprises at least a first NTN base station 101 and a second NTN base station 102. In the example of FIG. 1, NTN base stations 101 and 102 are LEO satellites orbiting around the earth with known/or predictable orbital parameters. However, it is to be noted that base stations 101 and 102 could be of any High-Altitude Platforms Systems (HAPS) including airplanes, balloons, or airships, or event terrestrial base stations. In some example, NTN base stations 101 and 102 are 5G NR base stations (gNodeB, or gNB).

FIG. 1 also shows a first User Equipment (UE) device 105 and a second User Equipment device 106, initially served in a source cell by base station 101. UE 105 and UE 106 may be of any type. For example, UE 105 may be a mobile phone, a connected vehicle or IoT device (Internet Of Things). UE 106 may also be a mobile phone, a connected vehicle or IoT device.

LEO satellites 101 and 102 are traveling along a predictable orbit at a constant speed relative to the earth's ground, for example at 7.56 km/s, thus making their respective radio beams 103 and 104 moving over time. UE 105, as well as other UE served in the same cell like UE 106, is therefore frequently handed over to a new target cell. Considering the large cell size of NTN, a potentially very large number of UEs may thus need to perform handover at the same time.

FIG. 2 is a call flow illustrating a traditional inter-cell state of art handover procedure. UE periodically transmits measurement reports regarding signal quality in a message 200. First gNB takes a decision 201 to handover UE when signal strength from second gNB becomes greater than signal strength from first gNB and sends a handover request 202 to a second gNB through inter-gNB Xn interface. Second gNB acknowledge the handover request in a message 204 transmitted to the first gNB after an admission check 203. First gNB then sends a handover command 205 (i.e. RRC reconfiguration message) to the UE to instruct UE to switch to the second gNB.

Upon reception of said handover command 205, UE synchronizes with second gNB and performs a random access procedure 206 to establish communication channels before sending a handover complete message 207 (i.e. RRC reconfiguration Complete message).

UE initiates such a random access procedure by randomly selecting a signature from a given set of signatures, and by transmitting a so-called preamble containing the selected signature to the second gNB. This preamble is also referred to as a “random access preamble”.

Since different UE can start a random access procedure on the common RACH channel at the same time, and because only a limited number of different signatures is available for selection, different UE may randomly select the same signature. If this happens, the unique identification of the respective UE and the messages coming from it or to it in the synchronization process is hindered by so called collisions. Therefore, the Random Access procedure may fail, resulting in a termination of the Random Access procedure, the UE must repeat the random access procedure at a later time.

It is easily understood that the risk of such collisions occurring is particularly high when a large number of UEs are transferred from a source gNB to a target gNB at the same time.

For a purpose of clarity, same references will be used to designate same entities across the following description.

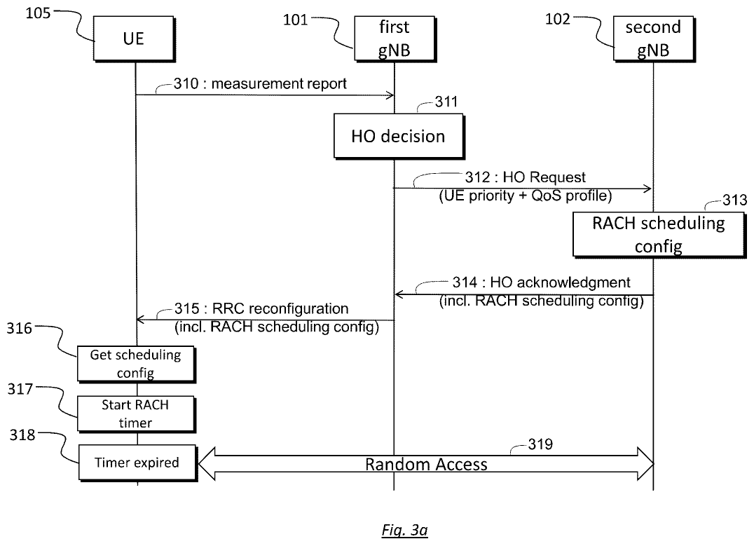

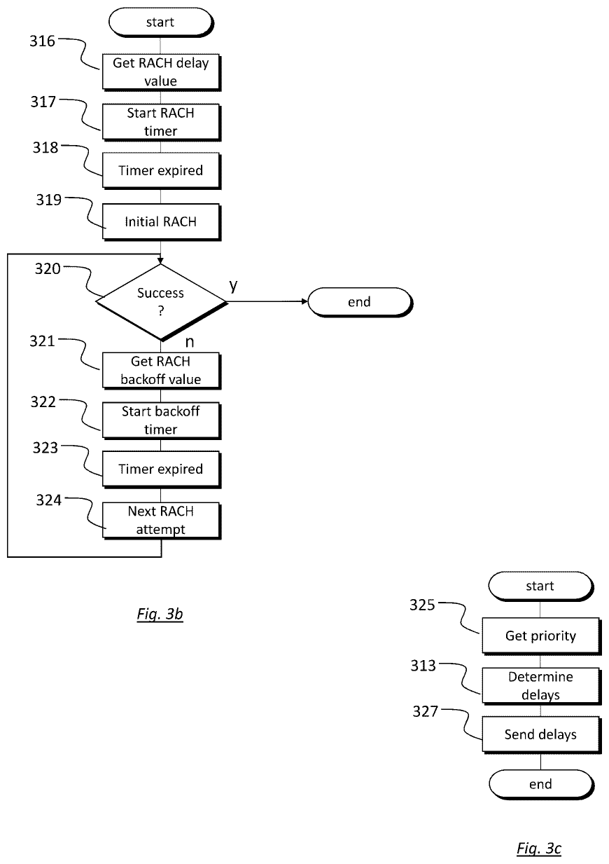

A first embodiment of a method of wireless communication for performing a handover will now be described with reference to FIGS. 3a, 3b and 3c.

FIG. 3a shows a combined flow chart and block diagram illustrating the main steps of a method of wireless communication for performing a handing over a UE 105 from a first base station 101 to a second base station 102, according to an embodiment.

UE 105 sends periodic or aperiodic reports message 310 comprising indications suitable for the serving gNB 101 to decide whether UE 105 should be handed over to another gNB serving a neighbor cell. Basically, such reports may include signal quality of the first gNB 101 and signal quality of a second gNB 102 serving neighbor cells. Such measurement reports are well known and used by the first gNB 101 to trigger a handover during a step 311 and will not be detailed further.

Once the first gNB 101 has decided that UE 105 should be handed over to another gNB, the source gNB 101 may send a handover request message 312 to the second gNB 102.

In an embodiment, the handover request message 312 comprises a priority associated with UE 105 and/or a QoS profile associated with UE 105. UE 105 may obtain said priority and/or QoS profile from first gNB 101 through MAC layer signaling, i.e. Logical Channel prioritization and/or 5QI signaling.

Second gNB 102 receives such a message 312 including priority and/or QoS profile of UE 105 during a step 325. The message 312 may be a handover request message or whatever suitable message sent over Xn interface.

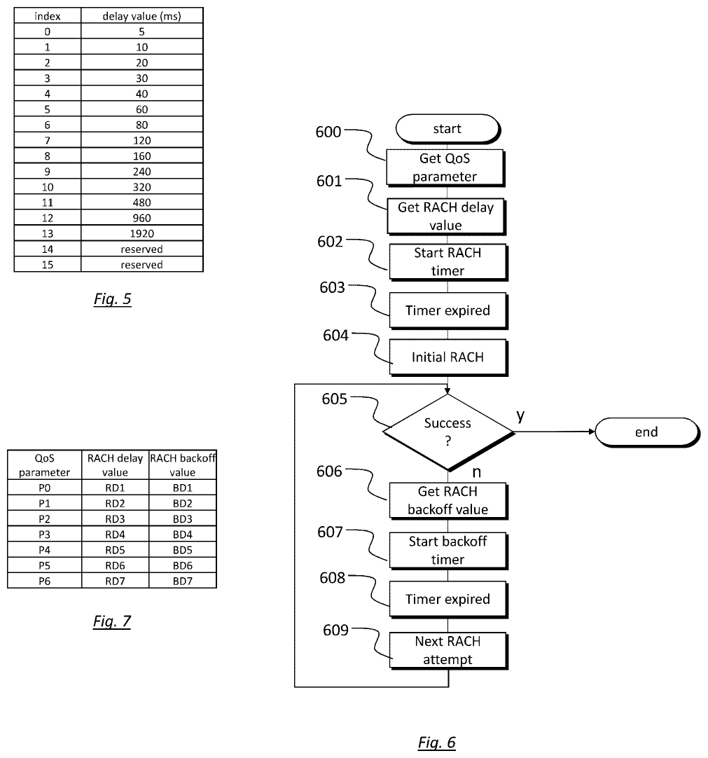

During a step 313, second gNB 102 determines a UE-specific random access scheduling configuration according to the priority and/or the QoS profile associated with UE 105. gNB 102 may determine random access delay timer value for each UE, and/or backoff timer value for each UE from a mapping table between UE priorities or QoS profiles and specific random access and/or backoff delays. In some embodiments, highest priority and/or QoS values would be associated with lower delay values in such mapping table. According to an embodiment, random access delay values and backoff delay values may be selected among a 3gpp-defined set of delay values as shown on FIG. 5.

In some embodiments, the determined random access scheduling configuration comprises at least a random access delay value that is determined according to said priority and/or QoS profile associated with UE 105. Such random access delay value is a waiting period to be observed by UE 105 before starting an initial random access attempt to the second gNB 102.

In some embodiments, the determined random access scheduling configuration comprises at least a backoff delay value that is determined according to said priority and/or QoS profile associated with UE 105. Such backoff delay value is a waiting period to be observed by UE 105 before a new random access attempt can be made if a first attempt has failed.

Second gNB 102 sends a handover acknowledgment message 314 to first gNB 101 at step 327, said message comprising at least the random access scheduling configuration determined for UE 105.

gNB 101 forwards the random access scheduling configuration received from gNB 102 to UE 105 in a handover command message 315, e.g. in a RRC reconfiguration message.

At step 316, UE 105 obtains the random access scheduling configuration transmitted by gNB 101 in the message 315. If the random access scheduling configuration comprises a random access delay timer value, UE 105 configures and starts a timer during a step 317 to delay the random access procedure.

When the scheduled Random access timer fires at step 318, UE 105 starts a random access procedure 319. Random access procedure is thus delayed from a time period that depends on the priority and or a QoS value associated with the UE 105.

It is thus possible to reduce the risk of contention by spreading out random access procedures. Moreover, random access procedures are delayed according to priorities and/or QoS profiles of UE to handover, while granting the best performance and response time to high priority UE.

In some embodiments, UE 105 may check at step 320 if random access procedure 319 has failed, for example because of a contention. When initial random access 319 fails, UE 105 may check if the received random access scheduling configuration includes a random access backoff value and obtain set backoff value during a step 321. UE 105 may then schedule a new timer at step 322 on the basis of said backoff timer value. Upon expiration of said timer at step 323, UE 105 may start a new random access attempt during step 324, thus further reducing the risk of collision while preserving a good quality of service for high priority UE. The steps of checking if random access has failed and performing a subsequent RACH attempt after expiration of timer scheduled with the backoff value may be repeated until a successful random access attempt.

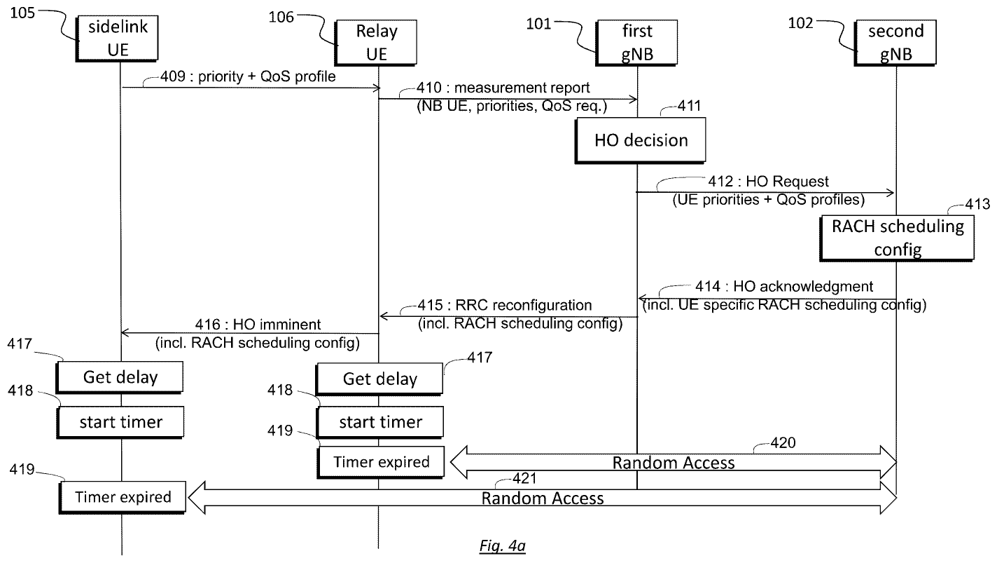

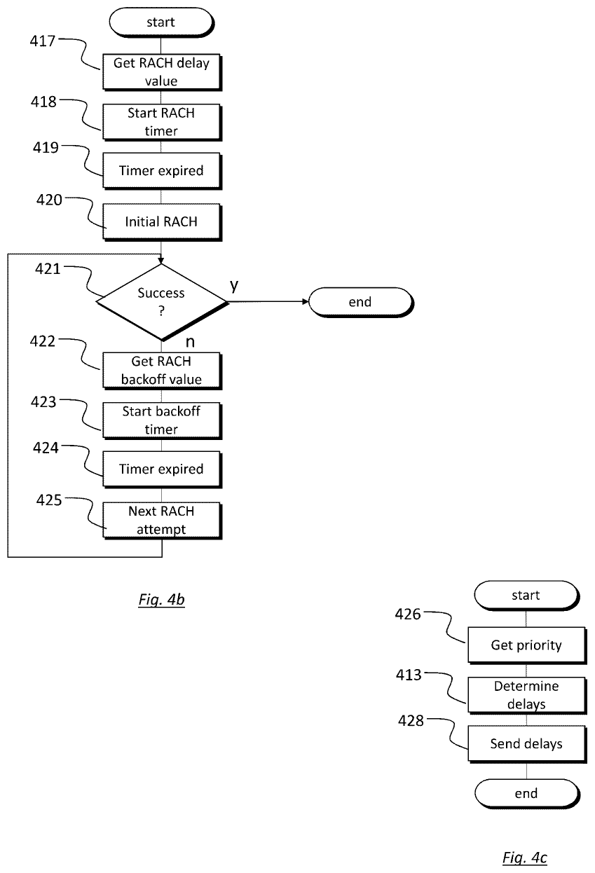

A second embodiment of a method of wireless communication for performing a handover will now be described with reference to FIGS. 4a, 4b and 4c.

FIG. 4a is a combined flow chart and block diagram illustrating the main steps of a method of wireless communication for performing a handing over a UE 105 and a relay UE 106 from a first base station 101 to a second base station 102, according to another embodiment.

FIG. 4 shows a so-called relay UE 106 initially served by gNB 101. Relay UE 106 aggregates the signaling of several “subordinates” or “sidelink” UE, including UE 105, in order to reduce signaling bandwidth overhead. UE 105 may communicate with relay UE 106 using ProSe sidelink communication. Sidelink communication may be provided by V2X PC5, DSRC, WiFi, LoRa ZigBee or Bluetooth communication interface. For the sake of clarity, only one subordinate UE 105 is handled by relay UE 106 in the example of FIG. 4. However, relay UE 106 may act as a signaling relay for a plurality of subordinates UE 105 for optimizing handover signaling overhead.

During a preliminary step, UE 105 attaches to the relay UE 106 using ProSe sidelink communication and sends its priority and QoS profile to relay UE 106 in a message 409. UE 105 may obtain its priority and/or QoS profile from gNB 101 through MAC layer signaling, i.e. Logical Channel prioritization and/or 5QI signaling. Thus, relay UE 106 maintains a list of registered UE including a priority and/or a QoS profile associated with each of said attached UE.

Relay UE 106 may send periodic or aperiodic report messages 410 comprising indications suitable for the gNB 101 to decide whether relay UE 106 and attached UE 105 should be handed over to another gNB serving a neighbor cell. Basically, such reports may include a value representative of a signal quality of the gNB 101 and signal quality of a gNB 102 serving neighbor cells as perceived by relay UE 106. Such measurement reports are well known and used by the serving gNB 101 to trigger a handover during a step 411 and will not be detailed further.

Measurement reports 410 sent by Relay UE 106 may include a list UE attached to the relay UE 106, as well as priorities and QoS profiles associated with said attached UE. In some implementation, the message 410 includes a list of UE managed by the relay UE 106, each entry of said list comprising an identifier of a UE, a QoS profile and a priority of the UE. In the example of FIG. 4a, we assume that UE 105 has a lower priority than UE 106.

In some embodiments, relay UE 106 includes its own priority and/or QoS profile within the list transmitted in measurement report 410. Relay UE 106 may obtain its priority and/or QoS profile from gNB 101 through MAC layer signaling, i.e. Logical Channel prioritization.

gNB 101 may take a handover decision during step 411. Once the gNB 101 has decided that relay UE 106 should be handed over by another gNB, gNB 101 sends a handover request message 412 to the second gNB 102.

In an embodiment, the handover request message 412 may include the list of managed UE received from the Relay UE 106, each entry of said list comprising an identifier of a UE, a QoS profile and/or a priority of the UE.

Said handover request message is received by second gNB 102 at a step 426.

During a step 413, second gNB 102 may determine a specific random access scheduling configuration for each UE within the list received from first gNB 101, the random access scheduling configuration being determined according to the priority and/or the QoS profile associated with each UE.

In some embodiments, the random access scheduling configuration determined for a specific UE comprises at least a random access delay value that is determined for said specific UE according to said priority and/or QoS profile associated with said UE. Such random access delay value is a waiting period to be observed by a UE before starting an initial random access attempt to the target gNB 102.

In some embodiments, the random access scheduling configuration determined for a specific UE comprises at least a backoff delay value that is determined for said specific UE managed by Relay UE 106 according to its priority and/or QoS profile. Such backoff delay value is a waiting period to be observed by UE before a new random access attempt can be made if a first attempt has failed.

gNB 102 may determine random access delay timer value for each UE, and/or backoff timer value for each UE from a predefined time range, i.e. UE associated with highest priority and/or QoS values would be assigned to the lower bound of said time range, whereas lowest priority and/or QoS values would be assigned to the highest bound of said time range.

According to an embodiment, random access delay values and backoff delay values may be selected among a 3gpp-defined set of delay values as shown on FIG. 5.

gNB 102 then sends a handover acknowledgment message 414 to gNB 101 during a step 428, said message comprising at least random access scheduling configurations determined for UE managed by Relay UE 106, e.g. for UE 105 in the example of FIG. 4. Each random access scheduling configuration may therefore be associated in the message 414 with an identifier of the UE for which it has been determined. In some implementation, the identifier of the UE may be a C-RNTI.

gNB 101 may forward received random access scheduling configurations along with corresponding UE identifiers to relay UE 106 in a handover command message 415, e.g. in a RRC reconfiguration message.

Upon reception of said handover command message 415, relay UE 106 may obtain a list of random access scheduling configurations transmitted by gNB 101 in the message 415, and dispatch a received random access scheduling configuration to the corresponding slave UE, for example in a handover imminent message 416.

In an embodiment, relay UE 106 may perform a step 417 of obtaining a random access scheduling configuration associated with its own identifier within the received message 415.

If the random access scheduling configuration associated with Relay UE identifier comprises a random access delay timer value, relay UE 106 perform a step 418 of configuring and starting a timer. When timer fires at step 419, relay UE 106 starts an initial random access procedure 420 to establish an uplink communication channel to gNB 102. The random access procedure 420 is thus delayed from a time period that depends on the priority and or a QoS value associated with the Relay UE 106.

UE 106 may check if the initial random access procedure 420 is successful during a step 421.

Whenever initial random access 420 fails, relay UE 106 may obtain a random access backoff value from the received message 415 during step 422, and schedule a new timer on the basis of said backoff timer value during step 423. When timer fires at step 425, UE 106 may start a new random access attempt 425. The steps of checking if random access has failed and performing a subsequent RACH attempt after expiration of timer scheduled with the backoff value may be repeated until a successful random access attempt.

Upon reception of message 416 including its specific random access configuration, UE 105 may also perform the step 417 of obtaining a random access scheduling configuration. UE 105 may obtains said random access configuration from received message 416. UE 105 performs the step 418 of scheduling and starting a timer according to the received random access scheduling configuration and in particular, according to a random access delay timer value included in said random access scheduling configuration.

In the example depicted on FIG. 4a, because the priority of UE 105 is lower than the priority of UE 106, the random access delay value associated with UE 105 is longer than the timer value received by UE 106. Therefore, the random access timer configured by UE 105 fires after the timer configured by UE 106.

When timer expires at step 419, UE 105 may start an initial random access procedure 421 in order to synchronize with target gNB 102. The random access procedure 421 is thus delayed from a time period that depends on the priority and or a QoS value associated with the UE 105.

Because the timer configured by UE 105 fires after the timer configured by UE 106 due to the highest priority of UE 106, the random access procedure 421 triggered by UE 105 occurs after the random access procedure 420. Therefore, contention is avoided.

Whenever initial random access 421 fails, UE 105 may obtain a random access backoff value from the received message 416 during step 422 and schedule a new timer on the basis of said backoff timer value during step 423. When timer fires at step 424, UE 106 may start a new random access attempt 425.

A third embodiment of the present disclosure will now be described with reference to FIG. 6.

This embodiment differs from the first and the second embodiments in that the random access scheduling configuration, including a random access delay value and/or a random access backoff delay value, may be obtained by a user equipment device from a preconfigured embedded mapping instead of being received in a message sent by another entity.

According to the third embodiment, user equipment 105 may receive a QoS requirement from a network node during a preliminary step 600. As an example, UE 105 receives a RRC signaling message sent by gNB 101, said RRC message comprising a QoS parameter. The QoS parameter may be a 5QI (5G QoS identifier). According to 3GPP 5G NR standard, when UE 105 makes a request for any types of service, 5G NR network automatically assigns a 5QI identifier for each user service with the required QoS (Quality of Service) and change technical parameters of the 5G network to fulfill requirements of each assigned 5QI.

UE 105 obtains the random access scheduling configuration during step 601 by looking-up, in a preconfigured lookup table, a random Access scheduling configuration associated with said received QoS parameter.

In some embodiments, the obtained random access scheduling configuration comprises at least a random access delay value. Such random access delay value is a waiting period to be observed by UE 105 before starting an initial random access attempt to a target gNB.

In some embodiments, the determined random access scheduling configuration comprises at least a backoff delay value. Such backoff delay value is a waiting period to be observed by UE 105 before a new random access attempt can be made in case of failure of a previous attempt.

An exemplary lookup table is shown on FIG. 7, wherein a particular QoS parameter value is associated to a random access delay value and a random access backoff value. As an example, a UE that has received a 5QI parameter P3 will obtain a random access scheduling configuration comprising RD4 random access delay value and BD4 random access backoff delay value.

Therefore, no additional signaling is required to obtain a random access scheduling configuration.

Upon reception of a handover command, UE 105 configures and starts a timer according to the obtained random access delay value during a step 602 to delay the random access procedure.

When the scheduled Random access timer fires at step 603, UE 105 starts an initial random access procedure 604. Random access procedure is thus delayed from a time period that depends on the priority and or a QoS value associated with the UE 105.

It is thus possible to reduce the risk of contention by spreading out the random access procedure. Moreover, random access procedures are delayed according to QoS parameter configured for the UE, thus granting the best performance and response time to UE with higher QoS requirements.

In some embodiments, UE 105 may check at step 605 if random access procedure 604 has failed, for example because of a contention. When initial random access 604 fails, UE 105 may check if the received random access scheduling configuration includes a random access backoff value and obtain set backoff value during a step 605. UE 105 may then schedule a new timer at step 607 on the basis of said backoff timer value. Upon expiration of said timer at step 608, UE 105 may start a new random access attempt during step 609, thus further reducing the risk of collision while preserving a good quality of service for high QoS UE. The steps of checking if random access has failed and performing a subsequent RACH attempt after expiration of timer scheduled with the backoff value may be repeated until a successful random access attempt.

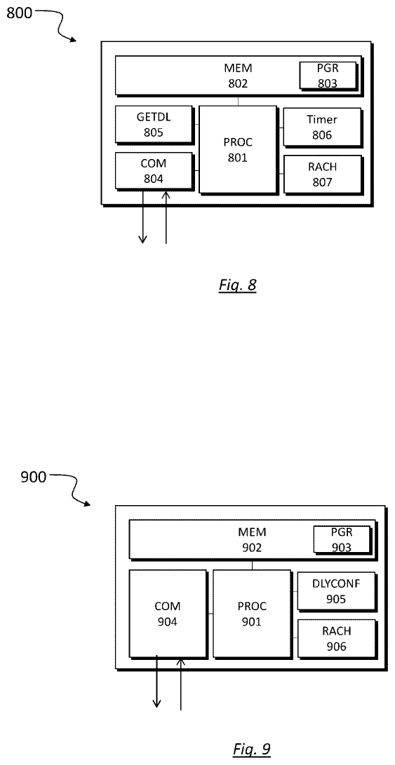

FIG. 8 shows a schematic architecture of an apparatus 800 suitable to implement a method of wireless communication for supporting a handover by a user equipment device, according to an embodiment.

The apparatus 800 comprises a processor 801 and a memory 802, for example a Random Access Memory (RAM). The processor 801 may be controlled by a computer program 803 stored in the memory 802 comprising instructions configured to implement a method of wireless communication for supporting a handover, according a particular embodiment.

More precisely, the computer program 803 comprises instructions to implement steps of:
Obtaining a Random Access scheduling configuration for at least said user equipment, said configuration including at least a Random Access delay value,
Starting a timer configured according to said Random Access Delay value upon reception of a handover command from the first base station, and
Triggering a delayed Random Access procedure to the second base station when timer expires.

On initialization, instructions of the computer program 803 may be loaded into the memory 802 before being executed by the processor 801. The processor 801 implements the steps of the method according to the instructions of the computer program 803.

The apparatus 800 comprises a wireless communication unit 804, for example a 3G, 4G, 5G, 5G NR, WiFi or WiMax transceiver for exchanging messages with other apparatus. In particular, communication unit 804 is configured to synchronize and exchange data with a base station of a wireless access network, for example a NodeB (NB), eNodeB (eNB) or gNodeB (gNB).

The apparatus 800 further comprises a RACH scheduling unit 805 configured to obtain a random access scheduling configuration comprising at least a specific random access delay value and/or a random access backoff delay value determined on the basis of a priority and/or a QoS profile associated with the apparatus 800. The RACH scheduling module may be implemented by computed program instructions arranged to configure the communication unit 804 to achieve the reception of a message comprising said random access scheduling configuration, and to extract from said received message a random access delay value and/or a random access backoff value. According to an embodiment, said message comprising said random access scheduling configuration is received from a base station serving the cell wherein the apparatus is located. According to another embodiment, said message comprising said random access scheduling configuration is received over a sidelink ProSe communication channel from a user equipment acting as a relay for the purpose of performing a group handover. According yet another embodiment, The RACH scheduling module may be implemented by computed program instructions arranged to configure the communication unit 804 to achieve the reception of a message comprising a QoS parameter, for example a 5QI parameter, and to lookup in a preconfigured mapping table to find out a random access scheduling configuration associated with said received QoS parameter.

The apparatus 800 further comprises a timer module 806 configured to trigger a random access procedure upon expiration of a time period. The timer module may be implemented by computed program instructions arranged to get a random access delay value from the scheduling unit 805, to schedule a timer using said delay value, and to command a RACH unit 807 in order to trigger a random access procedure upon expiration of said scheduled timer.

In some embodiment, the apparatus 800 is included in a user equipment, a mobile terminal, an IoT device, or a vehicle.

FIG. 9 shows a schematic architecture of an apparatus 900 suitable to implement a method of wireless communication for performing a handover by a base station, according to an embodiment.

The apparatus 900 comprises a processor 901 and a memory 902, for example a Random Access Memory (RAM). The processor 901 may be controlled by a computer program 903 stored in the memory 902 comprising instructions configured to implement a method of wireless communication for performing a handover, according a particular embodiment.

More precisely, the computer program 903 comprises instructions to implement steps of:
Receiving, from said second base station, a handover request comprising at least one priority value and/or a QoS profile associated with said at least one user equipment device,
Determining a Random Access scheduling configuration from said user equipment priority value and/or QoS profile, said Random Access scheduling configuration including at least a Random Access delay value,
Transmitting to said second base station, a handover response message including said determined Random Access scheduling configuration.

On initialization, instructions of the computer program 903 may be loaded into the memory 902 before being executed by the processor 901. The processor 901 implements the steps of the method according to instructions of the computer program 903.

The apparatus 900 comprises a wireless communication unit 904, for example a 3G, 4G, 5G, 5G NR, WiFi or WiMax transceiver for exchanging messages with other apparatus. In particular, communication unit 804 is configured to synchronize and exchange data with a base station of a wireless access network, for example a NodeB (NB), eNodeB (eNB) or gNodeB (gNB).

The communication unit 904 may be configured by computed program instructions to receive at least one QoS profile and/or priority associated with a particular UE. For example, the communication unit may be configured to receive a handover request message from a source base station comprising one or more identifier of UE served by said source base station, each of said identifier being associated with a specific priority value and/or QoS profile.

The apparatus 900 further comprise a random access scheduling configuration determination unit 905. Unit 905 may be configured by computer program instructions to obtain, from the communication unit 904, at least a received QoS profile and/or priority associated with a particular UE identifier, and to determine a random access scheduling configuration on the basis of said QoS and/or priority, said random access scheduling configuration including at least a random access delay value, and a random access backoff delay value. Configuration unit 905 may use a mapping table to determine a particular delay from a particular QoS or priority value.

Communication unit 904 may be further configured by computer program instructions to transmit to the source base station a message including at least one random access scheduling configuration determined by unit 904 associated with the corresponding UE identifier. In some examples, said transmitted message may be a handover acknowledgement message.

The apparatus 900 further comprises a random access unit 906 configured to support a delayed random access procedure initiated by a user equipment, the random access procedure being delayed according to a delay value determined for the UE by the determination unit 905.

In some embodiment, apparatus 900 is included in a cellular base station, for example in a terrestrial or non-terrestrial NodeB, eNodeB, gNodeB.

1. A method of wireless communication by a user equipment, for supporting a handover from a first base station to a second base station, the method comprising:
Obtaining a Random Access scheduling configuration for at least said user equipment, said configuration including at least a Random Access delay value,
Starting a timer configured according to said Random Access Delay value upon reception of a handover command from the first base station,
Triggering a delayed Random Access procedure to the second base station when timer expires.

2. The method of claim 1 wherein said Random Access scheduling configuration further comprises a Random Access back-off delay value, the method comprising a step of applying said back-off delay value upon Random Access Procedure failure.

3. A method according to claim 1 wherein said Random Access scheduling configuration is obtained from a message comprising said Random Access scheduling configuration.

4. A method according to claim 3 wherein said message comprising said random access scheduling configuration is received from said first base station.

5. A method according to claim 1 wherein said Random Access scheduling configuration is determined by said second base station according to a QoS profile and/or a priority associated with said user equipment.

6. A method according to claim 1 wherein obtaining said Random Access scheduling configuration comprises:
Receiving a RRC signaling message comprising a QoS parameter,
Looking-up, in a preconfigured lookup table, a Random Access scheduling configuration associated with said received QoS parameter.

7. A user equipment device for supporting a handover from a first base station to a second base station comprising a processor coupled with a memory with computer program instructions stored therein, wherein said processor is configured by said computer program instructions to:
Obtain a Random Access scheduling configuration for at least said user equipment, said configuration including at least a Random Access delay value,
Start a timer configured according to the determined Random Access Delay value upon reception of a handover command from the first base station,
Trigger a delayed Random Access procedure to the second base station when timer expires.

8. A method of wireless communication by a first base station for performing a handover of at least one user equipment from a second base station to said first base station, the method comprising:
Receiving, from said second base station, a handover request comprising at least one priority value and/or a QoS profile associated with said at least one user equipment device,
Determining a Random Access scheduling configuration from said user equipment priority value and/or QoS profile, said Random Access scheduling configuration including at least a Random Access delay value,
Transmitting to said second base station, a handover response message including said determined Random Access scheduling configuration.

9. A base station for performing a handover of at least one user equipment in a wireless network comprising a processor coupled with a memory with computer program instructions stored therein, wherein said processor is configured by said computer program instructions to implement a method of wireless communication for performing a handover comprising:
Receiving, from said second base station, a handover request comprising at least one priority value and/or a QoS profile associated with said at least one user equipment device,
Determining a Random Access scheduling configuration from said at least one user equipment priority value and/or QoS profile, said Random Access scheduling configuration including at least a Random Access delay value,
Transmitting to said second base station, a handover response message including said determined Random Access scheduling configuration.

10. A wireless communication system for performing a handover of at least one first user equipment from a first base station to a second base station, the second base station comprising a processor coupled with a memory with computer program instructions stored therein, wherein said processor is configured by said computer program instructions to implement a wireless communication handover by performing operations comprising:
Receiving, from said first base station, a handover request comprising at least one priority value and/or a QoS profile associated with said at least one user equipment device,
Determining at least one Random Access scheduling configuration from said at least one user equipment priority value and/or QoS profile, said Random Access scheduling configuration including at least a Random Access delay value,
Transmitting to said first base station, a handover response message including said determined at least one Random Access scheduling configuration, and
Wherein said at least one first user equipment device comprising a processor coupled with a memory with computer program instructions stored therein, wherein said processor is configured by said computer program instructions to:
Receive at least one Random Access scheduling configuration including at least a Random Access delay value,
Start a timer configured according to said received Random Access Delay value,
Trigger a delayed Random Access procedure to the second base station when timer expires.
